(19) United States
(12) Patent Application Publication
(10) Pub. No.: US 2018/0118899 A1
(43) Pub. Date: May 3, 2018

(54) FIBRILLATED DYNAMIC CROSS-LINKED POLYMER COMPOSITIONS AND METHODS OF THEIR MANUFACTURE AND USE

(71) Applicant: SABIC Global Technologies B.V., Bergen op Zoom (NL)

(72) Inventors: Vaidyanath RAMAKRISHNAN, Bergen op Zoom (NL); Satish Kumar GAGGAR, Hoover, AL (US); Frederico Marques Ferreira CUSTODIO, Leiria (PT); Johannes Martinus Dina GOOSSENS, Bergen op Zoom (NL); Ramon GROOTE, Oisterwijk (NL)

(21) Appl. No.: 15/560,874

(22) PCT Filed: Mar. 25, 2016
(86) PCT No.: PCT/US2016/024288

§ 371 Date: Sep. 22, 2017

Related U.S. Application Data
(60) Provisional application No. 62/138,807, filed on Mar. 26, 2015.

(51) Int. Cl. C08J 3/24; C08J 3/00; C08J 9/00; C08G 59/68; C08L 25/12; C08L 27/18; C08L 63/00; C08L 67/02; C07F 3/06

(52) U.S. Cl. CPC C08J 3/24; C08J 3/005; C08J 9/0061; C08G 59/68; C08L 25/12; C08G 2270/00; C08L 63/00; C08L 67/02; C07F 3/06; C08J 2463/02; C08L 2205/22; C08L 27/18

(57) ABSTRACT

Described herein are polymer compositions comprising a matrix polymer component comprising a dynamic cross-linked polymer composition; and a fibrillated fluoropolymer, a fibrillated fluoropolymer encapsulated by an encapsulating polymer, or a combination thereof. Methods of making and using these polymer compositions are also described.

### CROSS REFERENCE TO RELATED APPLICATION

The present application claims priority to U.S. application 62/138,807, filed Mar. 26, 2015, the entirety of which is incorporated herein by reference.

### BACKGROUND

“Dynamic cross-linked polymer compositions” represent a versatile class of polymers. The compositions feature a system of covalently cross-linked polymer networks and can be characterized by the shifting nature of their structure. At elevated temperatures, it is believed that the cross-links undergo transesterification reactions at such a rate that a flow-like behavior can be observed. Here, the polymer can be processed much like a viscoelastic thermoplastic. At lower temperatures these dynamic cross-linked polymer compositions behave more like classic thermosets. As the rate of inter-chain transesterification slows, the network becomes more rigid and static. The reversible nature of the network bonds allows these polymers to be heated and reheated, and reformed, as the polymers resist degradation and maintain structural integrity at high temperatures.

There remains a need in the art for methods of enhancing the mechanical and rheological properties of dynamic cross-linked polymer compositions.

### SUMMARY

The above-described and other deficiencies of the art are met by polymer compositions comprising a matrix polymer component comprising dynamic cross-linked polymer compositions and a fibrillated fluoropolymer, a fibrillated fluoropolymer encapsulated by an encapsulating polymer, or a combination thereof. Methods of preparing these polymer compositions by combining an epoxy-containing component, a polyester component or a carboxylic acid component, a transesterification catalyst, and a fluoropolymer, a fluoropolymer encapsulated by an encapsulating polymer, or a combination thereof; in an extruder at a temperature of up to 320° C., or up to about 320° C., for 15 minutes, or for about 15 minutes or less are also described. Articles prepared from the described polymer compositions are also within the scope of the disclosure.

The above described and other features are exemplified by the following drawings, detailed description, examples, and claims.

### BRIEF DESCRIPTION OF THE FIGURES

The following is a brief description of the figures wherein like elements are numbered alike and which are exemplary of the various embodiments described herein.

FIG. 1 depicts the oscillatory time sweep measurement curves representing the storage and loss modulus for a cross-linked polymer network.

FIG. 2 depicts the stress relaxation measurement curves representing the normalized modulus for a dynamic cross-linked polymer network.

FIG. 3 depicts the effect of encapsulated polytetrafluoroethylene on the complex viscosity of one embodiment of the disclosure.

FIG. 4 depicts a scanning electron microscope SEM micrograph (5000 times, 5000×) of one embodiment of the disclosure.

FIG. 5 depicts a scanning electron microscope SEM micrograph (4000×) of one embodiment of the disclosure.

### DETAILED DESCRIPTION OF ILLUSTRATIVE EMBODIMENTS

Described herein are polymer compositions comprising a matrix polymer component comprising a dynamic cross-linked polymer composition and a fibrillated fluoropolymer, a fibrillated fluoropolymer encapsulated by an encapsulating polymer, or a combination thereof. Methods of making and using these polymer compositions are also described.

The present disclosure may be understood more readily by reference to the following detailed description of desired embodiments and the examples included therein. In the following specification and the claims that follow, reference will be made to a number of terms which have the following meanings.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps. It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams (g) to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

As used herein, “Tm” refers to the melting point at which a polymer completely loses its orderly arrangement. As used herein, “Tc” refers to the crystallization temperature at which a polymer gives off heat to break a crystalline arrangement. The terms “Glass Transition Temperature” or “Tg” may be measured using a differential scanning calorimetry method and expressed in degrees Celsius.

As used herein, “cross-link” and its variants refer to the formation of a stable covalent bond between two polymers. This term is intended to encompass the formation of covalent bonds that result in network formation, or the formation of covalent bonds that result in chain extension. The term “cross-linkable” refers to the ability of a polymer to form such stable covalent bonds.

As used herein, “dynamic cross-linked polymer composition” refers to a class of polymer systems that include dynamically, covalently cross-linked polymer networks. At low temperatures, dynamic cross-linked polymer compositions behave like classic thermosets, but at higher temperatures, for example, temperatures up to about 320° C., it is theorized that the cross-links have dynamic mobility, resulting in a flow-like behavior that enables the composition to be processed and re-processed. Dynamic cross-linked polymer compositions incorporate covalently crosslinked networks that are able to change their topology through thermoactivated bond exchange reactions. The network is capable of reorganizing itself without altering the number of cross-links between its atoms. At high temperatures, dynamic cross-linked polymer compositions achieve transesterification rates that permit mobility between crosslinks, so that the network behaves like a flexible rubber. At low temperatures, exchange reactions are very long and dynamic cross-linked polymer compositions behave like classical thermosets. The transition from the liquid to the solid is reversible and exhibits a glass transition and/or a melting point. Put another way, dynamic cross-linked polymer compositions can be heated to temperatures such that they become liquid without suffering destruction or degradation of their structure. The viscosity of these materials varies slowly over a broad temperature range, with behavior that approaches the Arrhenius law. Because of the presence of the crosslinks, a dynamic cross-linked polymer composition will not lose integrity above the glass transition temperature (Tg) or the melting point (Tm) like a thermoplastic resin will. The crosslinks are capable of rearranging themselves via bond exchange reactions between multiple crosslinks and/or chain segments as described, for example, by Kloxin and Bowman, Chem. Soc. Rev. 2013, 42, 7161-7173. The continuous rearrangement reactions may occur at room or elevated temperatures depending upon the dynamic covalent chemistry applicable to the system. The respective degree of cross-linking may depend on temperature and stoichiometry. Dynamic cross-linked polymer compositions of the invention can have Tg of about 40 to about 60° C. An article made from a dynamic cross-linked polymer composition can be heated and deformed, and upon returning to the original temperature, maintains the deformed shape. This combination of properties permits the manufacture of shapes that are difficult or impossible to obtain by molding or for which making a mold would not be economical. Dynamic cross-linked polymer compositions generally have good mechanical strength at low temperatures, high chemical resistance, and a low coefficient of thermal expansion, along with processability at high temperatures. Examples of dynamic cross-linked polymer compositions are described herein, as well as in U.S. Patent Application No. 2011/0319524, WO 2012/152859; WO 2014/086974; D. Montarnal et al., Science 334 (2011) 965-968; and J. P. Brutman et al, ACS Macro Lett. 2014, 3, 607-610.

Examining the nature of a given polymer composition can distinguish whether the composition is cross-linked, reversibly cross-linked, or non-crosslinked, and distinguish whether the composition is conventionally cross-linked or dynamically cross-linked. Dynamically cross-linked networks feature bond exchange reactions proceeding through an associative mechanism, while reversible cross-linked networks feature a dissociative mechanism. That is, the dynamically cross-linked composition remains cross-linked at all times, provided the chemical equilibrium allowing cross-linking is maintained. A reversibly cross-linked network however shows network dissociation upon heating, reversibly transforming to a low-viscous liquid and then reforming the cross-linked network upon cooling. Reversibly cross-linked compositions also tend to dissociate in solvents, particularly polar solvents, while dynamically cross-linked compositions tend to swell in solvents as do conventionally cross-linked compositions.

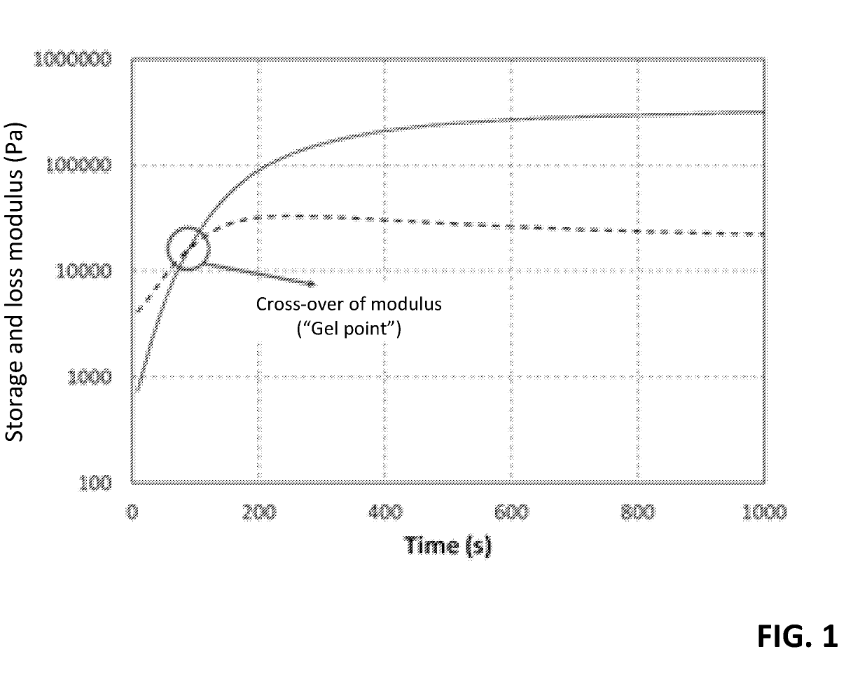

The cross-linked network apparent in dynamic and other conventional cross-linked systems may also be identified by rheological testing. An oscillatory time sweep (OTS) measurement at fixed strain and temperature may be used to confirm network formation. Exemplary OTS curves are presented in FIG. 1 for a cross-linked polymer network. The orientation of the curves indicates whether or not the polymer has a cross-linked network. Initially, the loss modulus (viscous component) has a greater value than the storage modulus (elastic component) indicating that the material behaves like a viscous liquid. Over time, polymer network formation is evidenced by the intersection of the loss and storage modulus curves. The intersection, referred to as the “gel point,” represents when the elastic component predominates the viscous component and the polymer begins to behave like an elastic solid.

In distinguishing between dynamic cross-linking and conventional (or non-reversible) cross-linking, a stress relaxation rheology measurement may also, or alternatively, be performed at constant strain and temperature.

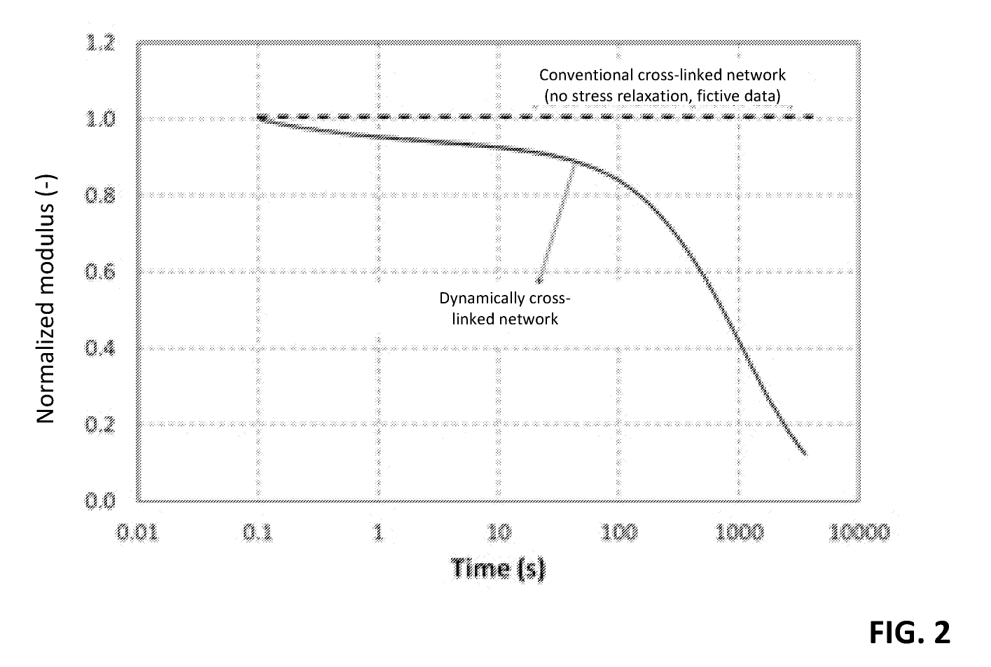

After network formation, the polymer may be heated and certain strain imposed on the polymer. The resulting evolution of the elastic modulus as a function of time reveals whether the polymer is dynamically or conventionally cross-linked. Exemplary curves for dynamically and conventionally cross-linked polymer networks are presented in FIG. 2. FIG. 2 presents the characteristic stress relaxation behavior with respect to modulus over time (in seconds) of a dynamically cross-linked polymer network, compared to the absence of the stress-relaxation phenomenon for a conventional cross-linked polymer network (dashed line, fictive data).

Stress relaxation generally follows a multimodal behavior:

$$G / {G}_{0} = {\sum }_{i = 1}^{n} {C}_{i} exp ( - t / {τ}_{i} )$$

where the number (n), relative contribution (Ci) and characteristic timescales (τi) of the different relaxation modes are governed by bond exchange chemistry, network topology and network density. For a conventional cross-linked networks, relaxation times approach infinity, τ→∞, and G/G0=1 (horizontal dashed line). Apparent in the curves for the normalized modulus (G/G0) as a function of time, a conventionally cross-linked network does not exhibit any stress relation because the permanent character of the cross-links prevents the polymer chain segments from moving with respect to one another. A dynamically cross-linked network, however, features bond exchange reactions allowing for individual movement of polymer chain segments thereby allowing for complete stress relation over time.

According to the disclosure, dynamically cross-linked polymer compositions have a characteristic timescale for relaxation of internal stresses of between 0.01 to 1,000,000 seconds, as measured by stress relaxation rheology experiments defined herein.

As used herein, a “pre-dynamic cross-linked polymer composition” refers to a mixture comprising the prescribed elements to form a dynamic cross-linked polymer composition, but which has not been cured sufficiently to establish the requisite level of cross-linking for forming a dynamic cross-linked polymer composition. Upon sufficient curing, for example, heating to temperatures up to 320° C., or up to about 320° C., a pre-dynamic cross-linked polymer composition will convert to a dynamic cross-linked polymer composition. Pre-dynamic cross-linked polymer compositions comprise an epoxy-containing component, a polyester component, and a transesterification catalyst, as well as optional additives.

As used herein, “matrix polymer component” refers to one or more polymers that are not fibrillated during the mixing processes described herein. According to the disclosure, the matrix polymer component comprises a dynamic cross-linked polymer composition. Other polymers can be present in the matrix polymer component, as well. Examples of suitable polymers that can be included in the matrix polymer component with the dynamic polymer composition include, but are not limited to, amorphous, crystalline, and semi-crystalline thermoplastic materials such as polyolefins (for example, linear or cyclic polyolefins such as polyethylene, chlorinated polyethylene, polypropylene, and the like); polyesters (for example, polyethylene terephthalate, polybutylene terephthalate, polycyclohexylmethylene terephthalate, and the like); arylate esters; polyamides; polysulfones (including hydrogenated polysulfones, and the like); polyimides; polyetherimides; polyether sulfones; polyphenylene sulfides; polyether ketones; polyether ether ketones; ABS resins; polystyrenes (for example hydrogenated polystyrenes, syndiotactic and atactic polystyrenes, hydrogenated polystyrenes such as polycyclohexyl ethylene, styrene-co-acrylonitrile, styrene-co-maleic anhydride, and the like); polybutadiene; polyacrylates (for example, polymethylmethacrylate (PMMA), methyl methacrylate-polyimide copolymers, and the like); polyacrylonitrile; polyacetals; polycarbonates; polyphenylene ethers (for example, those derived from 2,6-dimethylphenol and copolymers with 2,3,6-trimethylphenol, and the like); ethylene-vinyl acetate copolymers; polyvinyl acetate; liquid crystalline polymers; fluoropolymers such as ethylene-tetrafluoroethylene copolymer, polyvinyl fluoride, and polyvinylidene fluoride, polytetrafluoroethylene (provided that the fluoropolymer has a lower softening temperature than the fluoropolymer component described below); polyvinyl chloride, polyvinylidene chloride; and combinations comprising at least one of the foregoing polymers. The matrix polymer may generally be provided in any form, including but not limited to powders, plates, pellets, flakes, chips, whiskers, and the like.

Described herein are polymer compositions comprising a matrix polymer component comprising a dynamic cross-linked polymer compositions and a fibrillated fluoropolymer, a fibrillated fluoropolymer encapsulated by an encapsulating polymer, or a combination thereof. Preferably, the fibrillated fluoropolymer is substantially dispersed within the matrix polymer component. In various embodiments, the polymer compositions of the disclosure exhibit improved mechanical and rheological properties beyond those of their non-fibrillated matrix polymer counterparts. The disclosed polymer compositions have a flexural strength of 2500 MegaPascals (MPa) to 3500 MPa, or about 2500 MPa to about 3500 MPa, or preferably 2600 MPa to 3200 MPa, or about 2600 MPa to about 3200 MPa, more preferably 2600 MPa to 3100 MPa, or from about 2600 MPa to about 3100 MPa, where tensile modulus may be determined in accordance with ISO 527. In some embodiments, the improved modulus may be obtained without significant degradation of the other properties of the composition. In other embodiments, the improved modulus is obtained together with good ductility and/or good flow.

The impact strength of the polymer compositions can be determined in accordance with ISO 180. The polymer compositions of the disclosure exhibit an impact strength of from 1 kilojoules per square millimeter (KJ/mm²) to 10 KJ/mm², preferably about 2 KJ/mm² to about 8 KJ/mm², and more preferably from about 2 KJ/mm² to about 6 KJ/mm². In further examples, the polymer compositions of the disclosure exhibit an impact strength of from 1 KJ/mm² to 10 KJ/mm², for example, 1, 2, 3, 4, 5, 6, 7, 8, 9, or 10 KJ/mm², preferably 2 KJ/mm² to 8 KJ/mm², and more preferably from 2 KJ/mm² to 6 KJ/mm²

In accordance with ISO 6721-10, the polymer compositions can exhibit complex viscosities from 7×10⁶ Pa·s (Pascal-seconds) to 4×10⁷ Pa·s, or from about 7×10⁶ Pa·s (Pascal-seconds) to about 4×10⁷ Pa·s, measured at 0.001 rad/sec at 250° C. Extensional viscosities of 36,000 Pa·s to 20,0000 Pa·s, or about 36,000 Pas to about 20,0000 Pa·s, at a max Henky strain of 2.0 at a strain rate of 1 s⁻¹ can also be attained using a rheometer at 250° C. for 10 mm×20 mm×0.5 mm samples.

According to the disclosure, the polymer compositions comprise 0.1 wt. % to 15 wt. %, or from about 0.1 wt. % to about 15 wt. %, based on the weight of the polymer composition, of the fibrillated fluoropolymer, the fibrillated fluoropolymer encapsulated by an encapsulating polymer, or the combination thereof. In some embodiments, the polymer compositions comprise about 0.1, 0.2, 0.3, 0.4, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, or about 15 wt. %, based on the weight of the polymer composition, of the fibrillated fluoropolymer, the fibrillated fluoropolymer encapsulated by an encapsulating polymer, or the combination thereof.

Fluoropolymers suitable for use as the fluoropolymer component of the disclosure are capable of being fibrillated (“fibrillatable”) during mixing with the matrix polymer, the filler, or both simultaneously. “Fibrillation” is a term of art that refers to the treatment of fluoropolymers so as to produce, for example, a “node and fibril,” network, or cage-like structure. In one embodiment, the fluoropolymer comprises fibrils having an average diameter of 5 nanometers (nm) to 2 micrometers (m), or from about 5 nm to about 2 m. The fluoropolymer may also have an average fibril diameter of 30 nanometers to 750 nanometers, more specifically 5 nanometers to 500 nanometers. In a further example, the fluoropolymer may also have an average fibril diameter of about 30 nanometers to about 750 nanometers, more specifically about 5 nanometers to about 500 nanometers. Field Emission Scanning Electron Microscopy can be employed to observe the extent of fibrillation of the fluoropolymer throughout the matrix polymer in the fibrillated compositions.

Suitable fluoropolymers are described in U.S. Pat. No. 7,557,154 and include but are not limited to homopolymers and copolymers that comprise structural units derived from one or more fluorinated alpha-olefin monomers, that is, an alpha-olefin monomer that includes at least one fluorine atom in place of a hydrogen atom. In one embodiment the fluoropolymer comprises structural units derived from two or more fluorinated alpha-olefin, for example tetrafluoroethylene, hexafluoroethylene, and the like. In another embodiment, the fluoropolymer comprises structural units derived from one or more fluorinated alpha-olefin monomers and one or more non-fluorinated monoethylenically unsaturated monomers that are copolymerizable with the fluorinated monomers, for example alpha-monoethylenically unsaturated copolymerizable monomers such as ethylene, propylene, butene, acrylate monomers (e.g., methyl methacrylate and butyl acrylate), vinyl ethers, (e.g., cyclohexyl vinyl ether, ethyl vinyl ether, n-butyl vinyl ether, vinyl esters) and the like. Specific examples of fluoropolymers include polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, and ethylene chlorotrifluoroethylene. Combinations comprising at least one of the foregoing fluoropolymers may also be used.

As is known, fluoropolymers are available in a variety of forms, including powders, emulsions, dispersions, agglomerations, and the like. “Dispersion” (also called “emulsion”) fluoropolymers are generally manufactured by dispersion or emulsion, and generally comprise 25 to 60 weight percent (wt. %), or about 25 wt. % to 60 wt. %, fluoropolymer in water, stabilized with a surfactant, wherein the fluoropolymer particles are 0.1 to 0.3 micrometers (microns, μm), or about 0.1 μm to about 0.3 μm in diameter. “Fine powder” (or “coagulated dispersion”) fluoropolymers may be made by coagulation and drying of dispersion-manufactured fluoropolymers. Fine powder fluoropolymers are generally manufactured to have a particle size of 400 to 500 μm, or about 400 μm to about 500 μm. “Granular” fluoropolymers may be made by a suspension method, and are generally manufactured in two different particle size ranges, including a median particle size of 30 to 40 μm, or about 30 μm to about 40 μm and a high bulk density product exhibiting a median particle size of 400 to 500 μm, or about 400 μm to about 500 μm. Pellets of fluoropolymer may also be obtained and cryogenically ground to exhibit the desired particle size.

In one embodiment the fluoropolymer is at least partially encapsulated by an encapsulating polymer that may be the same as or different from the matrix polymer (hereinafter referred to as an “encapsulated polymer”). Without being bound by theory, it is believed that encapsulation may aid in the distribution of the fluoropolymer within the matrix, and/or compatibilize the fluoropolymer with the matrix.

Suitable encapsulating polymers accordingly include, but are not limited to, vinyl polymers, acrylic polymers, polyacrylonitrile, polystyrenes, polyolefins, polyesters, polyurethanes, polyamides, polysulfones, polyimides, polyetherimides, polyphenylene ethers, polyphenylene sulfides, polyether ketones, polyether ether ketones, acrylonitrile butadiene styrene (ABS) resins, polyethersulfones, poly(alkenylaromatic) polymers, polybutadiene, liquid crystalline polymers, polyacetals, polycarbonates, polyphenylene ethers, ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, and combinations comprising at least one of the foregoing polymers.

The encapsulating polymers may be obtained by polymerization of monomers or mixtures of monomers by methods known in the art, for example, condensation, addition polymerization, and the like. Emulsion polymerization, particularly radical polymerization may be used effectively. In one embodiment, the encapsulating polymer is formed from monovinylaromatic monomers containing condensed aromatic ring structures, such as vinyl naphthalene, vinyl anthracene and the like. Examples of suitable monovinylaromatic monomers include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene may be specifically mentioned. Other useful monomers for the formation of the encapsulating polymer include monovinylic monomers such as itaconic acid, acrylamide, N-substituted acrylamide or methacrylamide, maleic anhydride, maleimide, N-alkyl-, aryl-, or haloaryl-substituted maleimide, and glycidyl (meth)acrylates. Other monomers include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers.

Mixtures of the foregoing monovinylaromatic monomers and monovinylic monomers may also be used, for example mixtures of styrene and acrylonitrile (SAN). The relative ratio of monovinylaromatic and monovinylic monomers in the rigid graft phase may vary widely depending on the type of fluoropolymer, type of monovinylaromatic and monovinylic monomer(s), and the desired properties of the encapsulant. The encapsulant may generally be formed from up to 100 wt. %, or up to about 100 wt. %, of monovinyl aromatic monomer, specifically 30 to 100 wt. %, more specifically 50 to 90 wt. % monovinylaromatic monomer, with the balance being comonomer(s). In further examples, the encapsulant may generally be formed from up to about 100 wt. % of monovinyl aromatic monomer, specifically about 30 to about 100 wt. %, more specifically about 50 to about 90 wt. % monovinylaromatic monomer, with the balance being comonomer(s).

Elastomers may also be used as the encapsulating polymer, as well as elastomer-modified graft copolymers. Suitable elastomers include, for example, conjugated diene rubbers; copolymers of a conjugated diene with less than 50 wt. %, or less than about 50 wt. %, of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C1-8 alkyl (meth)acrylates; elastomeric copolymers of C1-8 alkyl (meth)acrylates with butadiene and/or styrene; or combinations comprising at least one of the foregoing elastomers.

Examples of conjugated diene monomers that may be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. Specific conjugated diene homopolymers include polybutadiene and polyisoprene.

Copolymers of conjugated diene rubbers may also be used, for example those produced by aqueous radical emulsion polymerization of a conjugated diene and up to 10 wt. %, or up to about 10 wt. %, of one or more monomers copolymerizable therewith.

(Meth)acrylate monomers suitable for use as an elastomeric encapsulating monomer include the cross-linked, particulate emulsion homopolymers or copolymers of C4-8 alkyl (meth)acrylates, in particular C4-6 alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. Exemplary comonomers include but are not limited to butadiene, isoprene, styrene, methyl methacrylate, phenyl methacrylate, phenethylmethacrylate, N-cyclohexylacrylamide, vinyl methyl ether or acrylonitrile, and mixtures comprising at least one of the foregoing comonomers. Optionally, up to 5 wt. % of a polyfunctional crosslinking comonomer may be present, for example divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing crosslinking agents.

Suitable elastomer-modified graft copolymers may be prepared by first providing an elastomeric polymer (for example, as described above), then polymerizing the constituent monomer(s) of the rigid phase in the presence of the fluoropolymer and the elastomer to obtain the graft copolymer. The elastomeric phase may provide 5 to 95 wt. % of the total graft copolymer, more specifically 20 to 90 wt. %, and even more specifically 40 to 85 wt. % of the elastomer-modified graft copolymer, the remainder being the rigid graft phase. In further examples, the elastomeric phase may provide about 5 to about 95 wt. % of the total graft copolymer, more specifically about 20 to about 90 wt. %, and even more specifically about 40 to about 85 wt. % of the elastomer-modified graft copolymer, the remainder being the rigid graft phase. Depending on the amount of elastomer-modified polymer present, a separate matrix or continuous phase of ungrafted rigid polymer or copolymer may be simultaneously obtained along with the elastomer-modified graft copolymer.

Specific encapsulating polymers include polystyrene, copolymers of polystyrene, poly(alpha-methylstyrene), poly(alpha-ethylstyrene), poly(alpha-propylstyrene), poly(alpha-butylstyrene), poly(p-methylstyrene), polyacrylonitrile, polymethacrylonitrile, poly(methyl acrylate), poly(ethyl acrylate), poly(propyl acrylate), and poly(butyl acrylate), poly(methyl methacrylate), poly(ethyl methacrylate), poly(propyl methacrylate), poly(butyl methacrylate); polybutadiene, copolymers of polybutadiene with propylene, poly(vinyl acetate), poly(vinyl chloride), poly(vinylidene chloride), poly(vinylidene fluoride), poly(vinyl alcohols), acrylonitrile-butadiene copolymer rubber, acrylonitrile-butadiene-styrene (ABS), poly(C4-8 alkyl acrylate) rubbers, styrene-butadiene rubbers (SBR), EPDM rubbers, silicon rubber and combinations comprising at least one of the foregoing encapsulating polymers. A preferred fluoropolymer is polytetrafluoroethylene.

Preferably, the encapsulating polymer comprises a styrene-acrylonitrile copolymer, an acrylonitrile-butadiene-styrene copolymer, alpha-alkyl-styrene-acrylonitrile copolymer, an alpha-methylstyrene-acrylonitrile copolymer, a styrene-butadiene rubber, a methyl methacrylate copolymer, or a combination thereof. In another embodiment, the encapsulating polymer comprises SAN, ABS copolymers, alpha-(C1-3)alkyl-styrene-acrylonitrile copolymers, alpha-methylstyrene-acrylonitrile (AMSAN) copolymers, SBR, and combinations comprising at least one of the foregoing. In yet another embodiment the encapsulating polymer is SAN or AMSAN. A preferred fluoropolymer encapsulated by an encapsulating polymer is styrene acrylonitrile encapsulated polytetrafluoroethylene.

Suitable amounts amount of encapsulating polymer may be determined by one of ordinary skill in the art without undue experimentation, using the guidance provided herein. In one embodiment, the encapsulated fluoropolymer comprises 10 to 90 weight percent (wt. %), or about 10 to about 90 wt. %, fluoropolymer and 90 to 10 wt. %, or about 90 wt. % to about 10 wt. %, of the encapsulating polymer, based on the total weight of the encapsulated fluoropolymer. Alternatively, the encapsulated fluoropolymer comprises 20 to 80 wt. %, or about 20 to about 80 wt. %, more specifically 40 wt. % to 60 wt. %, or about 40 to about 60 wt. % fluoropolymer, and 80 wt. % to 20 wt. %, or about 80 to about 20 wt. %, specifically, 60 wt. % or 40 wt. %, or about 60 about 40 wt. % encapsulating polymer, based on the total weight of the encapsulated polymer.

The dynamic polymer composition components of the disclosure are preferably prepared via the combination of, for example, an epoxy-containing component; a carboxylic acid component or a polyester component; and a transesterification catalyst. In one embodiment, the dynamic polymer composition components of the disclosure are prepared via the combination of an epoxy-containing component; a carboxylic acid component; and a transesterification catalyst. In other embodiments, the dynamic polymer composition components of the disclosure are preferably prepared via the combination of an epoxy-containing component; a polyester component; and a transesterification catalyst. The epoxy-containing component; the carboxylic acid component; the polyester component; and the transesterification catalyst are described in more detail infra.

The polymer compositions of the disclosure are preferably made by combining, in an extruder, the components of the dynamic polymer composition and the fluoropolymer and/or the fluoropolymer encapsulated by an encapsulating polymer. For example, in one embodiment, an epoxy-containing component, a polyester component or a carboxylic acid component, a transesterification catalyst, and a fluoropolymer, a fluoropolymer encapsulated by an encapsulating polymer, or a combination thereof are combined in an extruder. Preferably, the combining occurs at a temperature of up to 320° C., or up to about 320° C. In some embodiments, the temperature is between 40° C. and 280° C., or between about 40° C. and about 280° C. In some embodiments, the combining step occurs at temperatures of up to 320° C., or up to about 320° C. In yet other embodiments, the combining step occurs at temperatures of between 40° C. and 320° C., about 40° C. and about 320° C. In other embodiments, the combining step occurs at temperatures of between 40° C. and 290° C., about 40° C. and about 290° C. In some embodiments, the combining step occurs at temperatures of between 40° C. and 280° C., or between about 40° C. and about 280° C. In some embodiments, the combining step occurs at temperatures of between 40° C. and 270° C., or between about 40° C. and about 270° C. In other embodiments, the combining step occurs at temperatures of between 40° C. and 260° C., or between about 40° C. and about 260° C. In some embodiments, the combining step occurs at temperatures of between 40° C. and 250° C., or between about 40° C. and about 250° C. In yet other embodiments, the combining step occurs at temperatures of between 70° C. and 320° C., or between about 70° C. and about 320° C. In still other embodiments, the combining step occurs at temperatures of between 70° C. and 270° C., or between about 70° C. and about 270° C. In other embodiments, the combining step occurs at temperatures of between 70° C. and 240° C., or between about 70° C. and about 240° C. In yet other embodiments, the combining step occurs at temperatures of between 190° C. and 320° C., or between about 190° C. and about 320° C. In still other embodiments, the combining step occurs at temperatures of between 190° C. and 270° C., or between about 190° C. and about 270° C. In other embodiments, the combining step occurs at temperatures of between 190° C. and 240° C., or between about 190° C. and about 240° C. Suitable temperatures for the combining include about 40, 50, 60, 70, 80, 90, 100, 110, 120, 130, 140, 150, 160, 170, 180, 190, 200, 210, 220, 230, 240, 250, 260, 270, 280, 290, 300, 310, or about 320° C.

In preferred embodiments, the combining occurs for 15 minutes, or for about 15 minutes or less. In some embodiments, the combining occurs for less than 7 minutes, or less than about 7 minutes. In other embodiments, the combining step occurs for less than 4 minutes, or less than about 4 minutes. In yet other embodiments, the combining step occurs for less than 2.5 minutes, or less than about 2.5 minutes. In still other embodiments, the combining step occurs for between 10 minutes and 15 minutes, or between about 10 minutes and about 15 minutes.

The combining step can be achieved using any means known in the art, for example, mixing, including screw mixing, blending, stirring, shaking, and the like. A preferred method for combining is to use an extruder apparatus, for example, a single screw or twin screw extruding apparatus.

The methods described herein can be carried out under ambient atmospheric conditions, but it is preferred that the combining methods be carried out under an inert atmosphere, for example, a nitrogen atmosphere. Preferably, the methods are carried out under conditions that reduce the amount of moisture in the resulting polymer compositions described herein. For example, preferred polymer compositions described herein will have less than 3.0 wt. %, less than 2.5 wt. %, less than 2.0 wt. %, less than 1.5 wt. %, or less than 1.0 wt. % of water (i.e., moisture), based on the weight of the polymer composition. In a further example, the preferred polymer compositions described herein will have less than about 3.0 wt. %, less than about 2.5 wt. %, less than about 2.0 wt. %, less than about 1.5 wt. %, or less than about 1.0 wt. % of water (i.e., moisture), based on the weight of the polymer composition.

In some methods, the combining step can be carried out at atmospheric pressure. In other embodiments, the combining step can be carried out at a pressure that is less than atmospheric pressure. For example, in some embodiments, the combining step is carried out in a vacuum.

The individual components of the dynamic cross-linked polymer compositions of the disclosure are described in more detail herein.

Aspects of the present disclosure can relate to a method comprising: combining in an extruder an epoxy-containing component; a carboxylic acid component or a polyester component; a fibrillated fluoropolymer, a fibrillated fluoropolymer encapsulated by an encapsulating polymer, or a combination thereof, and a transesterification catalyst to form a mixture; and forming a network through heat treatment to form a dynamically cross-linked polymer composition, wherein the dynamically cross-linked composition comprises 0.1 wt. % to 15 wt. %, based on the weight of the polymer composition, of a fibrillated fluoropolymer, a fibrillated fluoropolymer encapsulated by an encapsulating polymer, or a combination thereof. By means of example and not to be limiting, heat treatment can include, post curing, thermoforming, compression molding, injection molding, or a combination thereof.

### Epoxy-Containing Component

The epoxy-containing component can be a monomer, an oligomer, or a polymer. Generally, the epoxy-containing component has at least two epoxy groups, and can also include other functional groups as desired, for example, hydroxyl (—OH). Glycidyl epoxy resins are a particularly preferred epoxy-containing component.

One exemplary glycidyl epoxy ether is bisphenol A diglycidyl ether (BADGE), which can be considered a monomer, oligomer or a polymer, and is shown below as Formula (A):

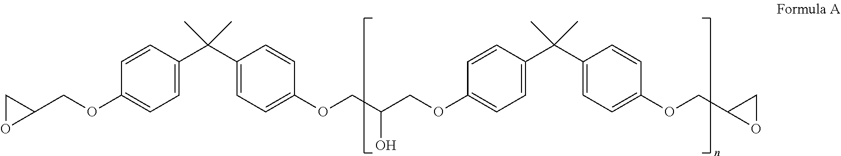

The value of n may be from 0 to 25 in Formula (A). When n=0, this is a monomer. When n=1 to 7, this is an oligomer. When n=8 to 25, this is a polymer. BADGE-based resins have excellent electrical properties, low shrinkage, good adhesion to numerous metals, good moisture resistance, good heat resistance and good resistance to mechanical impacts. BADGE oligomers (where n=1 or 2) are commercially available as D.E.R. 671 from Dow, which has an epoxide equivalent of 475 grams/equivalent-550 grams/equivalent, 7.8%-9.4% epoxide, 1820 mmol of epoxide/kilogram-2110 mmol of epoxide/kilogram, a melt viscosity at 150° C. of 400-950 mPa·sec, and a softening point of 75° C.-85° C.

Novolac resins can be used as the resin precursor as well. The epoxy resins are obtained by reacting phenol with formaldehyde in the presence of an acid catalyst to produce a novolac phenolic resin, followed by a reaction with epichlorohydrin in the presence of sodium hydroxide as catalyst. Epoxy resins are illustrated as Formula (B):

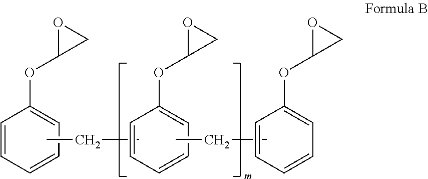

wherein m is a value from 0 to 25.

Another useful epoxide is depicted in Formula C.

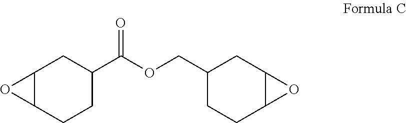 [SMILES: O=C(OCC1CCC2OC2C1)C1CCC2OC2C1]

Other useful epoxides are bi-functional terephthalic diglycidyl ethers. An example of such an epoxide is depicted in Formula D.

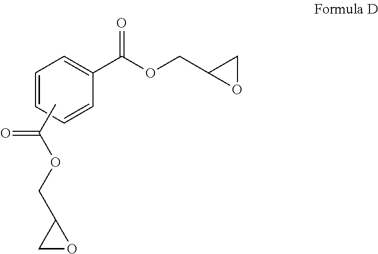

Other useful epoxides are tri-functional terephthalic diglycidyl ethers. An example of such an epoxide is depicted in Formula E.

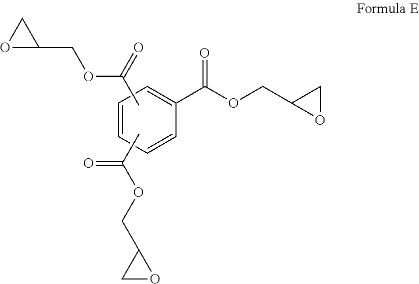

Mixtures of epoxide-containing components are also within the scope of the disclosure. For example, ARALDITE PT910 is a mixture of bi-functional and tri-functional glycidyl esters of terephthalic acid in a ratio of about 80:20, respectively. Within the scope of the disclosure, any ratio of epoxy components can be used.

### Polyester Component

Also present in the compositions described herein are polymers that have ester linkages, i.e., polyesters. The polymer can be a polyester, which contains only ester linkages between monomers. The polymer can also be a copolyester, which is a copolymer containing ester linkages and potentially other linkages as well.

The polymer having ester linkages can be a polyalkylene terephthalate, for example, poly(butylene terephthalate), also known as PBT, which has the structure shown below:

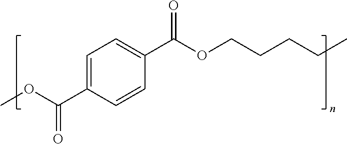

where n is the degree of polymerization, and can be as high as 1,000, and the polymer may have a weight average molecular weight of up to 100,000.

The polymer having ester linkages can be poly(ethylene terephthalate), also known as PET, which has the structure shown below:

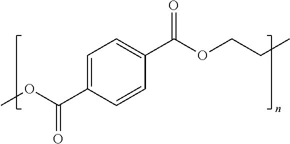

where n is the degree of polymerization, and can be as high as 1,000, and the polymer may have a weight average molecular weight of up to 100,000 Daltons.

The polymer having ester linkages can be PCTG, which refers to poly(cyclohexylenedimethylene terephthalate), glycol-modified. This is a copolymer formed from 1,4-cyclohexanedimethanol (CHDM), ethylene glycol, and terephthalic acid. The two diols react with the diacid to form a copolyester. The resulting copolyester has the structure shown below:

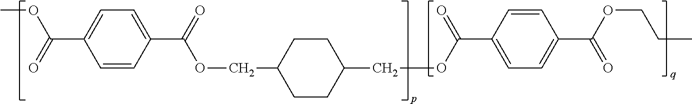

where p is the molar percentage of repeating units derived from CHDM, q is the molar percentage of repeating units derived from ethylene glycol, and p>q, and the polymer may have a weight average molecular weight of up to 100,000 Daltons.

The polymer having ester linkages can also be PETG. PETG has the same structure as PCTG, except that the ethylene glycol is 50 mole % or more of the diol content. PETG is an abbreviation for polyethylene terephthalate, glycol-modified.

The polymer having ester linkages can be poly(1,4-cyclohexane-dimethanol-1,4-cyclohexanedicarboxylate), i.e. PCCD, which is a polyester formed from the reaction of CHDM with dimethyl cyclohexane-1,4-dicarboxylate. PCCD has the structure shown below:

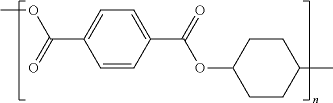

where n is the degree of polymerization, and can be as high as 1,000, and the polymer may have a weight average molecular weight of up to 100,000 Daltons.

The polymer having ester linkages can be poly(ethylene naphthalate), also known as PEN, which has the structure shown below:

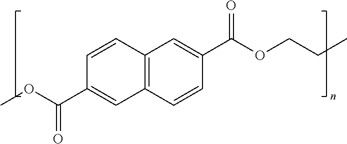

where n is the degree of polymerization, and can be as high as 1,000, and the polymer may have a weight average molecular weight of up to 100,000 Daltons.

The polymer having ester linkages can also be a copolyestercarbonate. A copolyestercarbonate contains two sets of repeating units, one having carbonate linkages and the other having ester linkages. This is illustrated in the structure below:

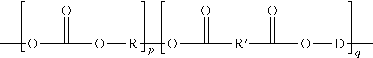

where p is the molar percentage of repeating units having carbonate linkages, q is the molar percentage of repeating units having ester linkages, and p+q=100%; and R, R′, and D are independently divalent radicals.

The divalent radicals R, R′, and D can be made from any combination of aliphatic or aromatic radicals, and can also contain other heteroatoms, such as for example oxygen, sulfur, or halogen. R and D are generally derived from dihydroxy compounds, such as the bisphenols of Formula (A). In particular embodiments, R is derived from bisphenol-A. R′ is generally derived from a dicarboxylic acid. Exemplary dicarboxylic acids include isophthalic acid; terephthalic acid; 1,2-di(p-carboxyphenyl)ethane; 4,4′-dicarboxydiphenyl ether; 4,4′-bisbenzoic acid; 1,4-, 1,5-, or 2,6-naphthalenedicarboxylic acids; and cyclohexane dicarboxylic acid. As additional examples, the repeating unit having ester linkages could be butylene terephthalate, ethylene terephthalate, PCCD, or ethylene naphthalate as depicted above.

Aliphatic polyesters can also be used. Examples of aliphatic polyesters include polyesters having repeating units of the following formula:

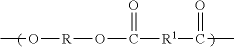

where at least one R or R¹ is an alkyl-containing radical. They are prepared from the polycondensation of glycol and aliphatic dicarbosylic acids.

By using an equimolar ratio between the hydroxyl/epoxy groups of the epoxy-containing component and the ester groups of the polymer having ester linkages, a moderately crosslinked polyhydroxy ester network can be obtained. The following conditions are generally sufficient to obtain a three-dimensional network:

N_{A}<N_{O}+2N_{X}

N_{A}>N_{X}

wherein N_{O} denotes the number of moles of hydroxyl groups; N_{X} denotes the number of moles of epoxy groups; and N_{A} denotes the number of moles of ester groups.

The mole ratio of hydroxyl/epoxy groups (from the epoxy-containing component) to the ester groups (from the polymer having ester linkages) in the system is generally from 1:100 to 5:100, or from about 1:100 to about 5 to 100.

### Transesterification Catalyst

Certain transesterification catalysts make it possible to catalyze the reactions described herein. The transesterification catalyst is used in an amount up to 25 mol %, or about 25 mol %, for example, 0.025 mol % to 25 mol % or about 0.025 mol % to about 25 mol %, of the total molar amount of ester groups in the polyester component. In some embodiments, the transesterification catalyst is used in an amount of from 0.025 mol % to 10 mol % or from 1 mol % to less than 5 mol %. In further embodiments, the transesterification catalyst is used in an amount of from about 0.025 mol % to about 10 mol % or from about 1 mol % to less than about 5 mol %. Preferred embodiments include 0.025, 0.05, 0.1, 0.2 mol % of catalyst, based on the number of ester groups in the polyester component. Alternatively, the catalyst is used in an amount from 0.1% to 10%, or about 0.1% to about 10%, by mass relative to the total mass of the reaction mixture, and preferably from 0.5% to 5%.

Transesterification catalysts are known in the art and are usually chosen from metal salts, for example, acetylacetonates, of zinc, tin, magnesium, cobalt, calcium, titanium, and zirconium.

Tin compounds such as dibutyltinlaurate, tin octanote, dibutyltin oxide, dioxtyltin, dibutyldimethoxytin, tetraphenyltin, tetrabutyl-2,3-dichlorodistannoxane, and all other stannoxanes are envisioned as suitable catalysts.

Rare earth salts of alkali metals and alkaline earth metals, particularly rare earth acetates, alkali metal and alkaline earth metals such as calcium acetate, zinc acetate, tin acetate, cobalt acetate, nickel acetate, lead acetate, lithium acetate, manganese acetate, sodium acetate, and cerium acetate are other catalysts that can be used.

Salts of saturated or unsaturated fatty acids and metals, alkali metals, alkaline earth and rare earth metals, for example zinc stearate, are also envisioned as suitable catalysts.

Other catalysts that can be used include metal oxides such as zinc oxide, antimony oxide, and indium oxide; metal alkoxides such as titanium tetrabutoxide, titanium propoxide, titanium isopropoxide, titanium ethoxide, zirconium alkoxides, niobium alkoxides, tantalum alkoxides; alkali metals; alkaline earth metals, rare earth alcoholates and metal hydroxides, for example sodium alcoholate, sodium methoxide, potassium alkoxide, and lithium alkoxide; sulfonic acids such as sulfuric acid, methane sulfonic acid, paratoluene sulfonic acid; phosphines such as triphenylphosphine, dimethylphenylphosphine, methyldiphenylphosphine, triterbutylphosphine; and phosphazenes.

The catalyst may also be an organic compound, such as benzyldimethylamide or benzyltrimethylammonium chloride. These catalysts are generally in solid form, and advantageously in the form of a finely divided powder. A preferred catalyst is zinc(II)acetylacetonate.

Suitable transesterification catalysts are also described in Otera, J. Chem. Rev. 1993, 93, 1449-1470. Tests for determining whether a catalyst will be appropriate for a given polymer system within the scope of the disclosure are described in, for example, U.S. Published Application No. 2011/0319524 and WO 2014/086974.

Polymer compositions of the disclosure may further comprises additives. Examples of such additives are described herein.

### Carboxylic Acid Component

Carboxylic acids react with epoxide groups to form esters. The presence of at least two carboxylic acid moieties is necessary to crosslink the dynamic cross-linked polymer compositions described herein. Carboxylic acid components comprising at least three carboxylic acid moieties enables the formation of a three-dimensional network.

The preparation of the compositions described herein may be performed with one or more carboxylic acid components, including at least one of the polyfunctional carboxylic acid type. Advantageously, the carboxylic acid component is chosen from: carboxylic acids in the form of a mixture of fatty acid dimers and trimers comprising from 2 to 40 carbon atoms, or from about 2 to about 40 carbon atoms.

Preferred carboxylic acid components can comprise 2 to 40 carbon atoms, such as linear diacids (glutaric, adipic, pimelic, suberic, azelaic, sebacic or dodecanedioic and homologues thereof of higher masses) and also mixtures thereof, or fatty acid derivatives. It is preferred to use trimers (oligomers of 3 identical or different monomers) and mixtures of fatty acid dimers and trimers, in particular of plant origin. These compounds result from the oligomerization of unsaturated fatty acids such as: undecylenic, myristoleic, palmitoleic, oleic, linoleic, linolenic, ricinoleic, eicosenoic or docosenoic acid, which are usually found in pine oil, rapeseed oil, corn oil, sunflower oil, soybean oil, grapeseed oil, linseed oil and jojoba oil, and also eicosapentaenoic acid and docosahexaenoic acid, which are found in fish oils.

Also preferred are aromatic carboxylic acid components comprising 2 to 40 carbon atoms, like aromatic diacids such as phthalic acid, trimellitic acid, terephthalic acid, naphthalenedicarboxylic acid.

Examples of fatty acid trimers include the compounds of the following formulae that illustrate cyclic trimers derived from fatty acids containing 18 carbon atoms, given that the compounds that are commercially available are mixtures of steric isomers and of positional isomers of these structures, which are optionally partially or totally hydrogenated.

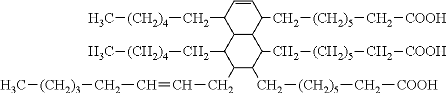

A mixture of fatty acid oligomers containing linear or cyclic C₁₈ fatty acid dimers, trimers and monomers, the said mixture predominantly being dimers and trimers and containing a small percentage (usually less than 5%) of monomers, may thus be used. Preferably, the said mixture comprises:
0.1% to 40% by weight and preferably 0.1% to 5% by weight of identical or different fatty acid monomers,
0.1% to 99% by weight and preferably 18% to 85% by weight of identical or different fatty acid dimers, and
0.1% to 90% by weight and preferably 5% to 85% by weight of identical or different fatty acid trimers.

Examples of fatty acid dimers/trimers include (weight %):
PRIPOL™ 1017 from Uniqema or Croda, mixture of 75-80% dimers and 18-22% trimers with about 1-3% fatty acid monomers,
PRIPOL™ 1048 from Uniqema or Croda, 50/50% mixture of dimers/trimers,
PRIPOL™ 1013 from Uniqema or Croda, mixture of 95-98% dimers and 2-4% trimers with 0.2% maximum of fatty acid monomers,
PRIPOL™ 1006 from Uniqema or Croda, mixture of 92-98% dimers and a maximum of 4% trimers with 0.4% maximum of fatty acid monomers,
PRIPOL™ 1040 from Uniqema or Croda, mixture of fatty acid dimers and trimers with at least 75% trimers and less than 1% fatty acid monomers,
UNIDYME™ 60 from Arizona Chemicals, mixture of 33% dimers and 67% trimers with less than 1% fatty acid monomers,
UNIDYME™ 40 from Arizona Chemicals, mixture of 65% dimers and 35% trimers with less than 1% fatty acid monomers,
UNIDYME™ 14 from Arizona Chemicals, mixture of 94% dimers and less than 5% trimers and other higher oligomers with about 1% fatty acid monomers,
EMPOL™ 1008 from Cognis, mixture of 92% dimers and 3% higher oligomers, essentially trimers, with about 5% fatty acid monomers,
EMPOL™ 1018 from Cognis, mixture of 81% dimers and 14% higher oligomers, essentially trimers, with about 5% fatty acid monomers,
RADIACID™ 0980 from Oleon, mixture of dimers and trimers with at least 70% trimers.

The products PRIPOL™, UNIDYME™, EMPOL™ and RADIACID™ comprise C₁₈ fatty acid monomers and fatty acid oligomers corresponding to multiples of C₁₈.

Other preferred carboxylic acid components include polyoxyalkylenes (polyoxoethylene, polyoxopropylene, etc.) comprising carboxylic acid functions at the ends, phosphoric acid, polyesters and polyamides, with a branched or unbranched structure, comprising carboxylic acid functions at the ends.

Preferably, the carboxylic acid component is chosen from: fatty acid dimers and trimers and polyoxyalkylenes comprising carboxylic acids at the ends.

The carboxylic acid component can also be in the form of an anhydride. Preferred anhydrides include cyclic anhydrides, for instance phthalic anhydride, methylnadic anhydride, hexahydrophthalic anhydride, dodecylsuccinic anhydride or glutaric anhydride. Other preferred anhydrides include succinic anhydride, maleic anhydride, chlorendic anhydride, nadic anhydride, tetrachlorophthalic anhydride, pyromellitic dianhydride, 1,2,3,4-cyclopentanetetracarboxylic acid dianhydride, and aliphatic acid polyanhydrides such as polyazelaic polyanhydride and polysebacic polyanhydride.

By using an equimolar ratio between the hydroxyl/epoxy groups of the epoxy-containing component and the carboxylic acid groups of the carboxylic acid component, a moderately crosslinked polyhydroxy ester network can be obtained. The following conditions are generally sufficient to obtain a three-dimensional network:

N_{A}<N_{O}+2N_{X}N_{A}>N_{X}

wherein N_{O} denotes the number of moles of hydroxyl groups; N_{X} denotes the number of moles of epoxy groups; and N_{A} denotes the number of moles of carboxylic acid groups. Additives

Other additives may be present in the compositions described herein, as desired. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, wood, glass, and metals, and combinations thereof.

Exemplary polymers that can be mixed with the compositions described herein include elastomers, thermoplastics, thermoplastic elastomers, and impact additives. The compositions described herein may be mixed with other polymers such as a polyester, a polyestercarbonate, a bisphenol-A homopolycarbonate, a polycarbonate copolymer, a tetrabromo-bisphenol A polycarbonate copolymer, a polysiloxane-co-bisphenol-A polycarbonate, a polyesteramide, a polyimide, a polyetherimide, a polyamideimide, a polyether, a polyethersulfone, a polyepoxide, a polylactide, a polylactic acid (PLA), an acrylic polymer, polyacrylonitrile, a polystyrene, a polyolefin, a polysiloxane, a polyurethane, a polyamide, a polyamideimide, a polysulfone, a polyphenylene ether, a polyphenylene sulfide, a polyether ketone, a polyether ether ketone, an acrylonitrile-butadiene-styrene (ABS) resin, an acrylic-styrene-acrylonitrile (ASA) resin, a polyphenylsulfone, a poly(alkenylaromatic) polymer, a polybutadiene, a polyacetal, a polycarbonate, an ethylene-vinyl acetate copolymer, a polyvinyl acetate, a liquid crystal polymer, an ethylene-tetrafluoroethylene copolymer, an aromatic polyester, a polyvinyl fluoride, a polyvinylidene fluoride, a polyvinylidene chloride, tetrafluoroethylene, or any combination thereof.

The additional polymer can be an impact modifier, if desired. Suitable impact modifiers may be high molecular weight elastomeric materials derived from olefins, monovinyl aromatic monomers, acrylic and methacrylic acids and their ester derivatives, as well as conjugated dienes that are fully or partially hydrogenated. The elastomeric materials can be in the form of homopolymers or copolymers, including random, block, radial block, graft, and core-shell copolymers.

A specific type of impact modifier may be an elastomer-modified graft copolymer comprising (i) an elastomeric (i.e., rubbery) polymer substrate having a Tg less than 10° C., or less than about 10° C., less than 0° C. or less than about 0° C., less than −10° C. or less than about −10° C., or between −40° C. to −80° C. or between about −40° C. to −80° C., and (ii) a rigid polymer grafted to the elastomeric polymer substrate. Materials suitable for use as the elastomeric phase include, for example, conjugated diene rubbers, for example polybutadiene and polyisoprene; copolymers of a conjugated diene with less than about 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁-C₈ alkyl(meth)acrylates; elastomeric copolymers of C₁-C₈ alkyl(meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific impact modifiers include styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). Exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

The compositions described herein may comprise an ultraviolet (UV) stabilizer for dispersing UV radiation energy. The UV stabilizer does not substantially hinder or prevent cross-linking of the various components of the compositions described herein. UV stabilizers may be hydroxybenzophenones; hydroxyphenyl benzotriazoles; cyanoacrylates; oxanilides; or hydroxyphenyl triazines. Specific UV stabilizers include poly[(6-morphilino-s-triazine-2,4-diyl)[2,2,6,6-tetramethyl-4-piperidyl) imino]-hexamethylene [(2,2,6,6-tetramethyl-4-piperidyl)imino], 2-hydroxy-4-octyloxybenzophenone (Uvinul™ 3008); 6-tert-butyl-2-(5-chloro-2H-benzotriazole-2-yl)-4-methylphenyl (Uvinul™ 3026); 2,4-di-tert-butyl-6-(5-chloro-2H-benzotriazole-2-yl)-phenol (Uvinul™ 3027); 2-(2H-benzotriazole-2-yl)-4,6-di-tert-pentylphenol (Uvinul™ 3028); 2-(2H-benzotriazole-2-yl)-4-(1,1,3,3-tetramethylbutyl)-phenol (Uvinul™ 3029); 1,3-bis[(2′-cyano-3′,3′-diphenylacryloyl)oxy]-2,2-bis-{[(2′-cyano-3′,3′-diphenylacryloyl)oxy]methyl}-propane (Uvinul™ 3030); 2-(2H-benzotriazole-2-yl)-4-methylphenol (Uvinul™ 3033); 2-(2H-benzotriazole-2-yl)-4,6-bis(1-methyl-1-phenyethyl) phenol (Uvinul™ 3034); ethyl-2-cyano-3,3-diphenylacrylate (Uvinul™ 3035); (2-ethylhexyl)-2-cyano-3,3-diphenylacrylate (Uvinul™ 3039); N,N′-bisformyl-N,N′-bis (2,2,6,6-tetramethyl-4-piperidinyl)hexamethylenediamine (Uvinul™ 4050H); bis-(2,2,6,6-tetramethyl-4-pipieridyl)-sebacate (Uvinul™ 4077H); bis-(1,2,2,6,6-pentamethyl-4-piperdiyl)-sebacate+methyl-(1,2,2,6,6-pentamethyl-4-piperidyl)-sebacate (Uvinul™ 4092H); or combinations thereof. Other UV stabilizers include Cyasorb 5411, Cyasorb UV-3638, Uvinul 3030, and/or Tinuvin 234.

The compositions described herein may comprise heat stabilizers. Exemplary heat stabilizer additives include, for example, organophosphites such as triphenyl phosphite, tris-(2,6-dimethylphenyl)phosphite, tris-(mixed mono- and di-nonylphenyl)phosphite, or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents may include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT™ 6321 (Sanyo) or PEBAX™ MH1657 (Atofina), IRGASTAT™ P18 and P22 (Ciba-Geigy). Other polymeric materials may be used as antistatic agents are inherently conducting polymers such as polyaniline (commercially available as PANIPOL™ EB from Panipol), polypyrrole and polythiophene (commercially available from Bayer), which retain some of their intrinsic conductivity after melt processing at elevated temperatures. Carbon fibers, carbon nanofibers, carbon nanotubes, carbon black, or a combination comprising at least one of the foregoing may be included to render the compositions described herein electrostatically dissipative.

The compositions described herein may comprise a radiation stabilizer, such as a gamma-radiation stabilizer. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-penten-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR²⁴HOH or —CR²⁴₂OH wherein R²⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl alcohol. 2-Methyl-2,4-pentanediol, polyethylene glycol, and polypropylene glycol are often used for gamma-radiation stabilization.

The term “pigments” means colored particles that are insoluble in the resulting compositions described herein. Exemplary pigments include titanium oxide, carbon black, carbon nanotubes, metal particles, silica, metal oxides, metal sulfides or any other mineral pigment; phthalocyanines, anthraquinones, quinacridones, dioxazines, azo pigments or any other organic pigment, natural pigments (madder, indigo, crimson, cochineal, etc.) and mixtures of pigments. The pigments may represent from 0.05% to 15%, or from about 0.05% to about 15%, by weight relative to the weight of the overall composition.

The term “dye” refers to molecules that are soluble in the compositions described herein and that have the capacity of absorbing part of the visible radiation.

Exemplary fibers include glass fibers, carbon fibers, polyester fibers, polyamide fibers, aramid fibers, cellulose and nanocellulose fibers or plant fibers (linseed, hemp, sisal, bamboo, etc.) may also be envisaged.

Pigments, dyes or fibers capable of absorbing radiation may be used to ensure the heating of an article based on the compositions described herein when heated using a radiation source such as a laser, or by the Joule effect, by induction or by microwaves. Such heating may allow the use of a process for manufacturing, transforming, or recycling an article made of the compositions described herein.

Suitable fillers for the compositions described herein include: silica, clays, calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (atmospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Plasticizers, lubricants, and mold release agents can be included. Mold release agent (MRA) will allow the material to be removed quickly and effectively. Mold releases can reduce cycle times, defects, and browning of finished product. There is considerable overlap among these types of materials, which may include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, i.e., methyl stearate and polyethylene-polypropylene glycol copolymer in a suitable solvent; waxes such as beeswax, montan wax, paraffin wax, or the like.

Various types of flame retardants can be utilized as additives. In one embodiment, the flame retardant additives include, for example, flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAlF₄, K₂SiF₆, and/or Na₃AlF₆ or the like. Rimar salt and KSS and NATS, alone or in combination with other flame retardants, are particularly useful in the compositions disclosed herein. In certain embodiments, the flame retardant does not contain bromine or chlorine.

The flame retardant additives may include organic compounds that include phosphorus, bromine, and/or chlorine. In certain embodiments, the flame retardant is not a bromine or chlorine containing composition. Non-brominated and non-chlorinated phosphorus-containing flame retardants can include, for example, organic phosphates and organic compounds containing phosphorus-nitrogen bonds. Exemplary di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Other exemplary phosphorus-containing flame retardant additives include phosphonitrilic chloride, phosphorus ester amides, phosphoric acid amides, phosphonic acid amides, phosphinic acid amides, tris(aziridinyl) phosphine oxide, polyorganophosphazenes, and polyorganophosphonates.

Some suitable polymeric or oligomeric flame retardants include: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; 2,2-bis-(3,5-dichloro-4-hydroxyphenyl)-propane; and 2,2-bis-(3-bromo-4-hydroxyphenyl)-propane. Other flame retardants include: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

The flame retardant optionally is a non-halogen based metal salt, e.g., of a monomeric or polymeric aromatic sulfonate or mixture thereof. The metal salt is, for example, an alkali metal or alkali earth metal salt or mixed metal salt. The metals of these groups include sodium, lithium, potassium, rubidium, cesium, beryllium, magnesium, calcium, strontium, francium and barium. Examples of flame retardants include cesium benzenesulfonate and cesium p-toluenesulfonate. See e.g., U.S. Pat. No. 3,933,734, EP 2103654, and US2010/0069543A1, the disclosures of which are incorporated herein by reference in their entirety.

Another useful class of flame retardant is the class of cyclic siloxanes having the general formula [(R)₂SiO]_{y} wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Exemplary antioxidant additives include organophosphites such as tris(nonyl phenyl)phosphite, tris(2,4-di-t-butylphenyl)phosphite (“IRGAFOS 168” or “1-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

The compositions described herein can also comprise polytetrafluoroethylene as an anti-drip agent. An anti-drip agent may be a fibril forming or non-fibril forming. As noted, polytetrafluoroethylene as an anti-drip agent can be neat or encapsulated in a copolymer.

### Processes, Properties, and Articles

Generally, the polymer compositions described can then be formed, shaped, molded, or extruded into a desired shape. Energy can be subsequently applied to cure the compositions described herein to form fibrillated dynamic cross-linked polymer compositions. For example, the polymer compositions can be heated to a temperature of from 50° C. to 250° C., or from about 50° C. to about 250° C., to effect curing. The cooling of the hardened compositions is usually performed by leaving the material to return to room temperature, with or without use of a cooling means. This process is advantageously performed in conditions such that the gel point is reached or exceeded by the time the cooling is completed. More specifically, sufficient energy should be applied during hardening for the gel point of the resin to be reached or exceeded.

Articles can also be prepared using the polymer compositions of the disclosure. As noted herein, “article” refers to the compositions described herein being formed into a particular shape.

With thermosetting resins of the prior art, once the resin has hardened (i.e. reached or exceeded the gel point), the article can no longer be transformed or repaired or recycled. Applying a moderate temperature to such an article does not lead to any observable or measurable transformation, and the application of a very high temperature leads to degradation of this article. In contrast, articles formed from the polymer compositions described herein, on account of their particular composition, can be transformed, repaired, or recycled by raising the temperature of the article. From a practical point of view, this means that over a broad temperature range, the article can be deformed, with internal constraints being removed at higher temperatures. Without being bound by theory, it is believed that transesterification exchanges in the dynamic cross-linked polymer compositions are the cause of the relaxation of constraints and of the variation in viscosity at high temperatures. In terms of application, these materials can be treated at high temperatures, where a low viscosity allows injection or molding in a press. It should be noted that, contrary to Diels-Alder reactions, no depolymerisation is observed at high temperatures and the material conserves its crosslinked structure. This property allows the repair of two parts of an article. No mold is necessary to maintain the shape of the components during the repair process at high temperatures. Similarly, components can be transformed by application of a mechanical force to only one part of an article without the need for a mold, since the material does not flow.

Raising the temperature of the article can be performed by any known means such as heating by conduction, convection, induction, spot heating, infrared, microwave, or radiant heating. Devices for increasing the temperature of the article in order to perform the processes of described herein can include: an oven, a microwave oven, a heating resistance, a flame, an exothermic chemical reaction, a laser beam, a hot iron, a hot-air gun, an ultrasonication tank, a heating punch, etc. The temperature increase can be performed in discrete stages, with their duration adapted to the expected result.

Although the dynamic cross-linked polymer compositions described herein, do not flow during the transformation, by means of the transesterification reactions, by selecting an appropriate temperature, heating time and cooling conditions, the new shape may be free of any residual internal constraints. The newly shaped polymer compositions are thus not embrittled or fractured by the application of the mechanical force. Furthermore, the article will not return to its original shape. Specifically, the transesterification reactions that take place at high temperature promote a reorganisation of the crosslinking points of the polymer network so as to remove any stresses caused by application of the mechanical force. A sufficient heating time makes it possible to completely cancel these stresses internal to the material that have been caused by the application of the external mechanical force. This makes it possible to obtain stable complex shapes, which are difficult or even impossible to obtain by molding, by starting with simpler elemental shapes and applying mechanical force to obtain the desired more complex final shape. Notably, it is very difficult to obtain by molding shapes resulting from twisting. Furthermore, the reinforcing fluoropolymer fibrils can enhance this durability and resiliency the dynamic cross-linked compositions.

According to one variant, a process for obtaining and/or repairing an article based on a fibrillated dynamic cross-linked polymer composition described herein comprises: placing in contact with each other two articles formed from a fibrillated dynamic cross-linked polymer composition; and heating the two articles so as to obtain a single article. The heating temperature (T) is generally within the range from 50° C. to 250° C., or from about 50° C. to about 250° C., including from 100° C. to 200° C. or from about 100° C. to about 200° C. An article made of polymer compositions as described herein may also be recycled by direct treatment of the article, for example, the broken or damaged article is repaired by means of a transformation process as described above and may thus regain its prior working function or another function. Alternatively, the article is reduced to particles by application of mechanical grinding, and the particles thus obtained may then be used to manufacture a new article.

In general, the polymer compositions of the disclosure can be molded into useful articles by a variety of means, for example injection molding, extrusion molding, rotation molding, foam molding, calendar molding, blow molding, thermoforming, compaction, melt spinning, and the like, to form articles. Because of their advantageous mechanical characteristics, especially preferred are articles that will be exposed to ultraviolet (UV) light, whether natural or artificial, during their lifetimes, and most particularly outdoor and indoor articles.

The disclosure further contemplates additional fabrication operations on said articles, such as, but not limited to, molding, in-mold decoration, baking in a paint oven, lamination, and/or thermoforming. The articles made from the composition of the present disclosure may be used widely in automotive industry, home appliances, electrical components, and telecommunications.

Aspects

The present disclosure pertains to and includes at least the following aspects.

Aspect 1. A polymer composition comprising: a matrix polymer component comprising a dynamic cross-linked polymer composition; and about 0.1 wt. % to about 15 wt. %, based on the weight of the polymer composition, of a fibrillated fluoropolymer, a fibrillated fluoropolymer encapsulated by an encapsulating polymer, or a combination thereof.

Aspect 2. A polymer composition consisting essentially of: a matrix polymer component comprising a dynamic cross-linked polymer composition; and about 0.1 wt. % to about 15 wt. %, based on the weight of the polymer composition, of a fibrillated fluoropolymer, a fibrillated fluoropolymer encapsulated by an encapsulating polymer, or a combination thereof.

Aspect 3. A polymer composition consisting of: a matrix polymer component comprising a dynamic cross-linked polymer composition; and about 0.1 wt. % to about 15 wt. %, based on the weight of the polymer composition, of a fibrillated fluoropolymer, a fibrillated fluoropolymer encapsulated by an encapsulating polymer, or a combination thereof.

Aspect 4. A polymer composition comprising: a matrix polymer component comprising a dynamic cross-linked polymer composition; and 0.1 wt. % to 15 wt. %, based on the weight of the polymer composition, of a fibrillated fluoropolymer, a fibrillated fluoropolymer encapsulated by an encapsulating polymer, or a combination thereof.

Aspect 5. A polymer composition consisting essentially of: a matrix polymer component comprising a dynamic cross-linked polymer composition; and 0.1 wt. % to abut 15 wt. %, based on the weight of the polymer composition, of a fibrillated fluoropolymer, a fibrillated fluoropolymer encapsulated by an encapsulating polymer, or a combination thereof.

Aspect 6. A polymer composition consisting of: a matrix polymer component comprising a dynamic cross-linked polymer composition; and 0.1 wt. % to 15 wt. %, based on the weight of the polymer composition, of a fibrillated fluoropolymer, a fibrillated fluoropolymer encapsulated by an encapsulating polymer, or a combination thereof.

Aspect 7. The polymer composition of aspect 1, wherein the fluoropolymer comprises polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, ethylene chlorotrifluoroethylene, or a combination thereof.

Aspect 8. The polymer composition of any one of the preceding aspects, wherein the encapsulating polymer comprises a styrene-acrylonitrile copolymer, an acrylonitrile-butadiene-styrene copolymer, alpha-alkyl-styrene-acrylonitrile copolymer, an alpha-methylstyrene-acrylonitrile copolymer, a styrene-butadiene rubber, a methyl methacrylate copolymer, or a combination thereof.

Aspect 9. The polymer composition of any one of the preceding aspects, wherein the fluoropolymer is polytetrafluoroethylene.

Aspect 10. The polymer composition of any one of the preceding aspects, wherein the fluoropolymer encapsulated by an encapsulating polymer is styrene acrylonitrile encapsulated polytetrafluoroethylene.

Aspect 11. The polymer composition of any one of the preceding aspects, wherein the dynamic polymer composition is produced by combining an epoxy-containing component; a carboxylic acid component or a polyester component; and a transesterification catalyst.

Aspect 12. The polymer composition of any one of the preceding aspects, wherein the fluoropolymer comprises about 5 wt. % of the total weight of the polymer composition.

Aspect 13. The polymer composition of any one of the preceding aspects, wherein the fluoropolymer comprises 5 wt. % of the total weight of the polymer composition.

Aspect 14. The polymer composition of any one of the preceding aspects, wherein the fluoropolymer comprises 0.05 wt. % to 5 wt. % of the total weight of the polymer composition.

Aspect 15. The polymer composition of any one of the preceding aspects, wherein the fluoropolymer comprises about 0.05 wt. % to about 5 wt. % of the total weight of the polymer composition.

Aspect 16. The polymer composition of any one of the preceding aspects, wherein the polymer composition has a tensile modulus of at least about 2600 Mpa; an impact strength of at least about 2.5 KJ/mm²; a complex viscosity of at least about of at least about 7×10⁶ Pa·s, measured at 0.001 rad/sec at 250° C.; or an extensional viscosity of at least about 36,000 Pas at a max Henky strain of 2.0 at a strain rate of 1 s⁻¹, measured at 250° C.

Aspect 17. The polymer composition of any one of the preceding aspects, wherein the polymer composition has a tensile modulus of at least 2600 Mpa; an impact strength of at least 2.5 KJ/mm²; a complex viscosity of at least of at least 7×10⁶ Pa·s, measured at 0.001 rad/sec at 250° C.; or an extensional viscosity of at least about 36,000 Pa s at a max Henky strain of 2.0 at a strain rate of 1 s⁻¹, measured at 250° C.

Aspect 18. The polymer composition of any one of the preceding aspects, wherein the polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

Aspect 19. An article comprising the polymer composition of any one of the preceding aspects.

Aspect 20. A method of forming a polymer composition comprising: combining in an extruder an epoxy-containing component, a polyester component or a carboxylic acid component, a transesterification catalyst, and a fluoropolymer, a fluoropolymer encapsulated by an encapsulating polymer, or a combination thereof; at a temperature of up to about 320° C. for about 15 minutes or less.

Aspect 21. The method of aspect 20, wherein the fluoropolymer is present in an amount from about 0.1 wt. % to about 1 wt. % of the total weight of the polymer composition.

Aspect 22. The method of aspect 20 or aspect 21, wherein the fluoropolymer comprises polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, ethylene chlorotrifluoroethylene, or a combination thereof.

Aspect 23. The method of aspect any one of aspects 20-22, wherein the encapsulating polymer comprises a styrene-acrylonitrile copolymer, an acrylonitrile-butadiene-styrene copolymer, alpha-alkyl-styrene-acrylonitrile copolymer, an alpha-methylstyrene-acrylonitrile copolymer, a styrene-butadiene rubber, a methyl methacrylate copolymer, or a combination thereof.

Aspect 24. The method of any one of aspects 20-23, wherein the temperature is between 40° C. and 280° C.

Aspect 25. The method of any one of aspects 20-24, wherein the temperature is between about 40° C. and about 280° C.

Aspect 26. The method of any one of aspects 20-25, wherein the combining occurs for between about 10 and 15 minutes or less than about 7 minutes.

Aspect 27. The method of any one of aspects 20-26, wherein the combining occurs for between 10 and 15 minutes or less than 7 minutes.

Aspect 28. The method of any one of aspects 20-27, wherein the epoxy-containing component is bisphenol A diglycidyl ether.

Aspect 29. The method of any one of aspects 20-28, wherein the polyester component is a polyalkylene terephthalate.

Aspect 30. The method of any one of aspects 20-29, wherein the transesterification catalyst is zinc(II)acetylacetonate.

Aspect 31. An article comprising the polymer composition prepared according to the method of any one of aspects 11-28.

Aspect 32. The article of aspect 31, wherein the article is prepared from the composition by thermoforming, blow-molding, sheet or profile extrusion processes, or a combination thereof

The following examples are provided to illustrate the compositions, processes, and properties of the present disclosure. The examples are merely illustrative and are not intended to limit the disclosure to the materials, conditions, or process parameters set forth therein.

### EXAMPLES

### Materials

PBT315 (molecular weight 110,000) (SABIC)
D.E.R.™ 671 (a solid epoxy resin that is the reaction product of epichlorohydrin and bisphenol A) (Dow Benelux B.V.)
Zinc(II)acetylacetonate (H₂O) (Acros)
ULTRANOX™ 1010 (an antioxidant) (BASF)
   An admixture of PBT, D.E.R. 671, zinc(II)acetylacetonate, and Ultranox (PBT-Comp) was prepared. See Table 1.

TABLE 1
Matrix polymer composition (PBT-Comp) comprising
pre-dynamic cross-linked composition components.

| | PBT-Comp |
|---|---|
| | (wt. %) |
| PBT 315 | 94.53 |
| D.E.R. 671 | 5.26 |
| Zn(acac)₂*H2O | 0.113 |
| Ultranox 1010 | 0.1 |

### Formation of Fibrillated Pre-Dynamic Cross-Linked Polymer Compositions

Compositions were prepared by compounding PBT 315 and PTFE or a combination of PBT 315, D.E.R.™ 671, zinc(II)acetylacetonate(H2O), and PTFE using a Werner & Pfeiderer Extruder ZSK 25 mm co-rotating twin screw extruder with the settings set forth in Table 2 using the following residence times: 2.4 minutes, 4.2 minutes, 6.8 minutes, and 8.7 minutes. The amount of PTFE was determined according to its form (either neat or encapsulated in a styrene acrylonitrile copolymer) in an amount as a percentage of the weight of the PBT or the total combined weight of PBT 315, D.E.R.™ 671, zinc(II)acetylacetonate(H₂O), and Ultranox 1010. The component mixtures included 0.15 wt. % to 10 wt. % TSAN or 0.15 wt. % to 5 wt. % neat PTFE to ensure equivalent amounts of PTFE regardless of its form (neat or encapsulated in a rigid copolymer).

TABLE 2
Compounding Settings

| Extruder | 25 mm ZSK Extruder | |
|---|---|---|
| Die | 2 | hole |
| Feed Temp | 40° | C. |
| Zone 1 Temp | 70° | C. |
| Zone 2 Temp | 190° | C. |
| Zone 3 Temp | 240° | C. |
| Zone 4 Temp | 270° | C. |
| Zone 5 Temp | 270° | C. |
| Zone 6 Temp | 270° | C. |
| Zone 7 Temp | 270° | C. |
| Zone 8 Temp | 270° | C. |
| Die Temp | 270° | C. |
| Screw Speed | 300 | rpm |
| Throughput | 15-20 | kg/hr |
| Vacuum 1 | −0.8 | bar |

The compositions formed after compounding that have not cross-linked thereby forming a dynamic cross-linked polymer composition, readily dissolve in hexafluoro isopropanol (HFIP). A dynamic cross-linked polymer composition does not dissolve in HFIP. Instead these cross-linked polymers swell, presumably as solvent is taken up into the polymer network.

Notwithstanding the polarity of the high polarity of the fluoropolymer, PTFE is not miscible with the molten polymer matrix (PBT-Comp). The PTFE however formed fibrils creating an interpenetrating network throughout the matrix polymer composition of PBT-Comp. The extrusion process and subsequent injection molding oriented the PTFE fibrils.

The compounded compositions were injection molded using an Engel 90 tons, equipped with an Axxion insert mold with the settings as set forth in Table 3. Molded samples were prepared in accordance with the ISO impact and tensile bars. The dimensions of the tensile bar were 170 mm×10 mm×4 mm and the dimensions of the impact bars were 80 mm×10 mm×4 mm with type A 2 mm notch. The gauge length used was 50 mm.

TABLE 3
Injection Molding Settings

| Molding Machine | Engel 90 tons | |
|---|---|---|
| Pre-drying time | 2 | hours |
| Pre-drying temp | 120° | C. |
| Hopper temp | 40° | C. |
| Zone 1 temp | 250° | C. |
| Zone 2 temp | 260° | C. |
| Zone 3 temp | 270° | C. |
| Nozzle temp | 270° | C. |
| Mold temp | 50° | C. |
| Screw speed | 40% | |
| Back pressure | 5 | bar |
| Injection speed | 26-107 | mm/s |
| Approx. cycle time | 26-107 | s |

| | |
|---|---|
| Mold Type (Axxicon insert) | 2 × 4.0 mm ISO tensile |

### Mechanical Properties

As shown in Table 4, the polymer compositions exhibit improved impact strength and tensile modulus.

TABLE 4
Impact strength for polymer matrix admixture (PBT-Comp)
comprising neat or encapsulated polytetrafluoroethylene
(PTFE or TSAN), respectively at various percentages.

| | Impact | | Impact |
|---|---|---|---|
| TSAN | Strength | PTFE | Strength |
| (wt. %) | (KJ/mm²) | (wt. %) | (KJ/mm²) |
| 0 | 2.5 | 0 | 3.5 |
| 2 | 5.7 | 0.5 | 3.8 |
| 3 | 5.4 | 1 | 4.1 |
| 5 | 5.4 | 2.5 | 4.1 |
| — | — | 5 | 4.5 |

Measurements of impact strength were observed according to ISO 180 (2011). The tests revealed that the introduction of PTFE into the polymer matrix (PBT-Comp) increases the impact strength of the composition. Furthermore, those compositions incorporating the copolymer encapsulated PTFE (TSAN) showed a higher impact strength than those featuring neat PTFE introduced during compounding. An increase of 3 KJ/mm² (from 2.5 KJ/mm² to 5.5 KJ/mm²) was observed with the addition of TSAN at 2%. For the corresponding neat PTFE amount of 1%, the impact strength increased only to 4.1 KJ/mm².

Table 5 presents the values observed for tensile modulus.

TABLE 5
Tensile modulus for polymer matrix admixture
at various amounts of TSAN or neat PTFE.

| TSAN | Modulus | PTFE | Modulus |
|---|---|---|---|
| (wt. %) | (MPa) | (wt. %) | (MPa) |
| 0 | 2908 | 0 | 2595 |
| 0.15 | 2846 | 0.15 | 2675 |
| 0.3 | 2891 | 0.5 | 2800 |
| 1 | 2867 | 1 | 3025 |
| 2 | 2983 | 2.5 | 3050 |
| 2 | 3041 | 5 | 3015 |
| 3 | 3090 | — | — |
| 5 | 3087 | — | — |
| 10 | 3063 | — | — |

The tensile modulus of each sample was determined according to ISO 527 (2012). Regardless of form, as the percent of PTFE is increased throughout the polymer matrix composition, the values for tensile modulus increase and then begin to slightly decrease. For example, at 2% TSAN the modulus is 3000 MPa compared to 2900 MPa in the absence of TSAN. As observed with impact strength, the PBT-Comp samples comprising TSAN exhibit a slightly higher overall tensile modulus at the corresponding percentages for compositions containing neat PTFE powder. As an example, at 1% TSAN, the tensile strength is 2867 MPa. At the corresponding 0.5% neat PTFE, the tensile strength is 2800 MPa. As the values begin to decline, at 5% TSAN the tensile strength is 3087 MPa and at the corresponding 2.5% neat PTFE, the tensile strength is 3050 MPa.

### Rheological Properties

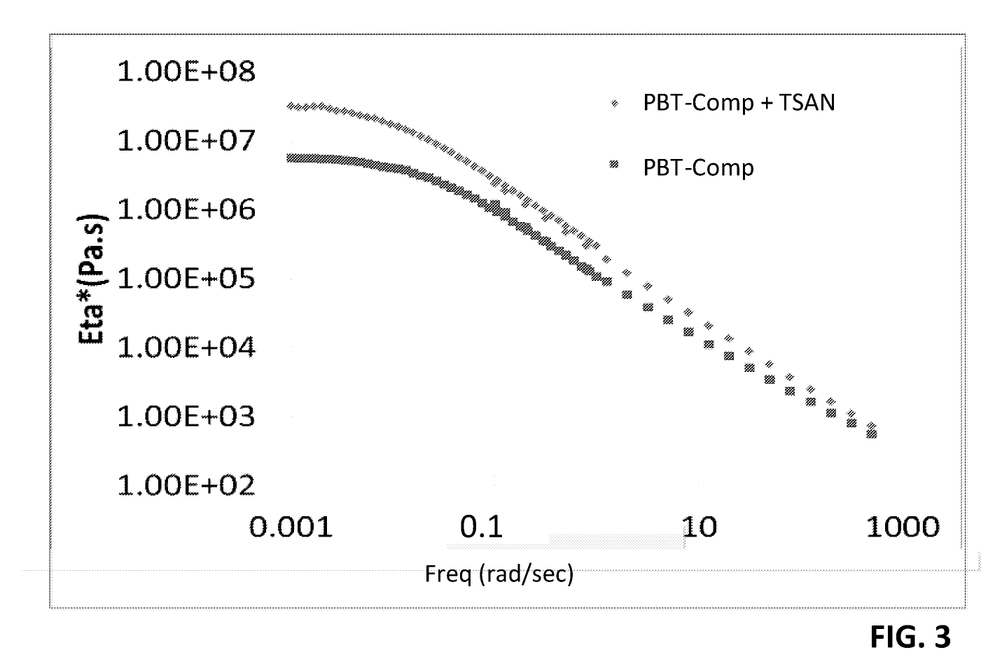

The magnitude of complex velocity η* was observed at different angular frequencies ω according to ISO 6721-10 (1999) at a temperature of 250° C. FIG. 3 presents the values for complex viscosity of the polymer matrix (PBT-Comp) and the polymer matrix admixture with TSAN. The oscillatory measurements for the fibrillated dynamic cross-linked polymer composition provide a higher, and steeper, curve than that for the non-fibrillated dynamic cross-linked PBT-Comp. The difference in oscillatory measurements suggests that the polymer matrix comprising TSAN is more frequency dependent, and thus more fluid-like, or viscous.

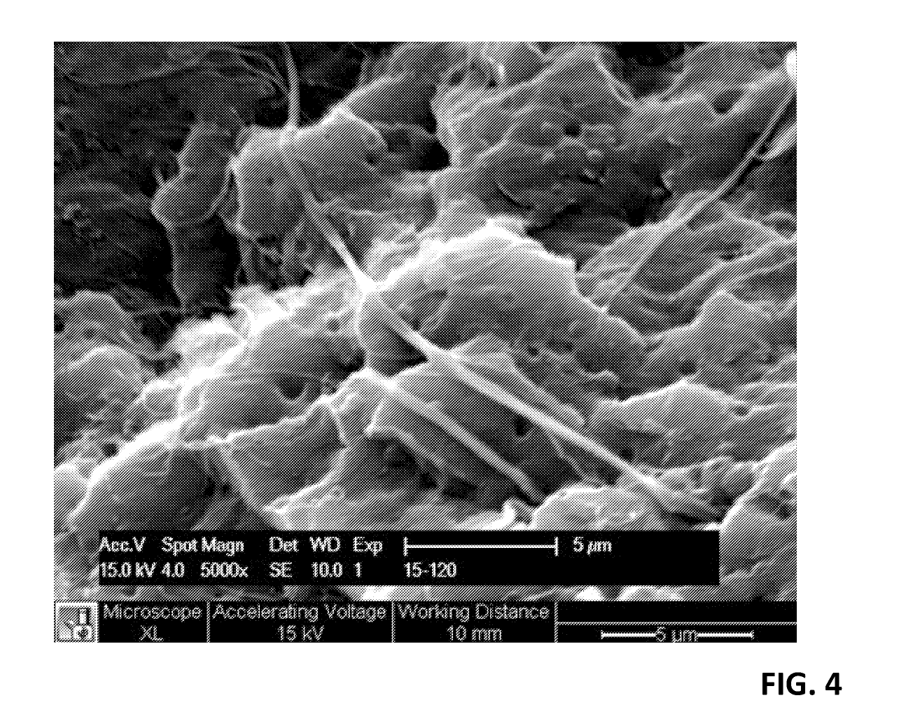

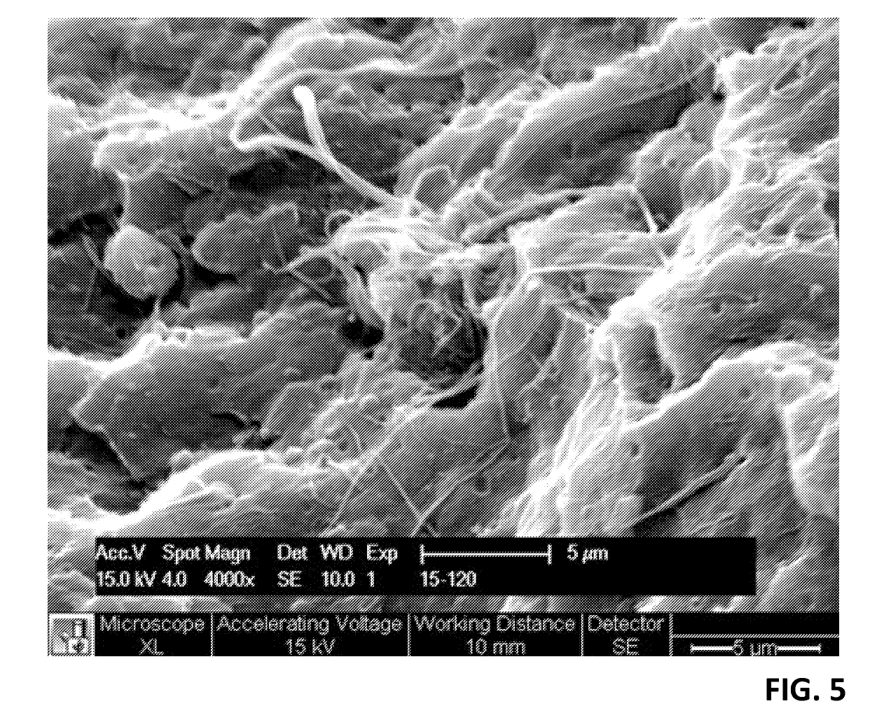

Extensional viscosity, or elongational viscosity, refers to the resistance of a substance to stretching motion or stress. The extensional viscosity was assessed for polymer admixture compositions at 0% PTFE, 2.5% neat PTFE, 5% TSAN, and 10% TSAN as a function of time. Measurements were obtained using a Sentmanat Extension Rheometer Universal Testing Platform (by Xpansion Instruments) at 250° C. at a constant strain rate of 1 s⁻¹. The molded sample size for testing was 10 mm×20 mm×0.5 mm. In the absence of TSAN or neat PTFE, the PBT-Comp exhibits increasing values over time. Nevertheless, the viscosity is consistently higher for all samples further comprising PTFE or encapsulated PTFE (TSAN). The extensional viscosities observed were consistently higher for samples including any PTFE or TSAN. Scanning electron microscope micrographs of PBT-315 DCN nanocomposites at 2% TSAN presented in FIGS. 4 and 5 showing the fibrillation of the compositions at 5000 times and 4000 times magnification, respectively. As can be seen the fibrils form a 3D network throughout the sample and have dimensions ranging from 50-200 nm with some bundles.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A polymer composition comprising:
a matrix polymer component comprising a dynamic cross-linked polymer composition; and
0.1 wt. % to 15 wt. %, based on the weight of the polymer composition, of a fibrillated fluoropolymer, a fibrillated fluoropolymer encapsulated by an encapsulating polymer, or a combination thereof.

2. The polymer composition of claim 1, wherein the fluoropolymer comprises polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, ethylene chlorotrifluoroethylene, or a combination thereof.

3. The polymer composition of claim 1, wherein the encapsulating polymer comprises a styrene-acrylonitrile copolymer, an acrylonitrile-butadiene-styrene copolymer, alpha-alkyl-styrene-acrylonitrile copolymer, an alpha-methylstyrene-acrylonitrile copolymer, a styrene-butadiene rubber, a methyl methacrylate copolymer, or a combination thereof.

4. The polymer composition of claim 1, wherein the fluoropolymer is polytetrafluoroethylene.

5. The polymer composition of claim 1, wherein the fluoropolymer encapsulated by an encapsulating polymer is styrene acrylonitrile encapsulated polytetrafluoroethylene.

6. The polymer composition of claim 1, wherein the dynamic polymer composition is produced by combining
an epoxy-containing component;
a carboxylic acid component or a polyester component; and
a transesterification catalyst.

7. The polymer composition of claim 1, wherein the fluoropolymer comprises 0.05 wt. % to 5 wt. % of the total weight of the polymer composition.

8. The polymer composition of claim 1, wherein the polymer composition:
has a tensile modulus of at least 2600 Mpa;
an impact strength of at least 2.5 KJ/mm²;
a complex viscosity of at least of at least 7×10⁶ Pa·s, measured at 0.001 rad/sec at 250° C.; or
an extensional viscosity of at least 36,000 Pa·s at a max Henky strain of 2.0 at a strain rate of 1 s¹, measured at 250° C.

9. The polymer composition of claim 1, wherein the polymer composition further comprises a pigment, a dye, a filler, a plasticizer, a fiber, a flame retardant, an antioxidant, a lubricant, wood, glass, metal, an ultraviolet agent, an anti-static agent, an anti-microbial agent, or a combination thereof.

10. A method of forming a polymer composition comprising:
combining in an extruder
an epoxy-containing component,
a polyester component or a carboxylic acid component,
a transesterification catalyst, and
a fluoropolymer, a fluoropolymer encapsulated by an encapsulating polymer, or a combination thereof;
at a temperature of up to 320° C. for 15 minutes or less.

11. The method of claim 10, wherein the fluoropolymer is present in an amount from 0.1 wt. % to 1 wt. % of the total weight of the polymer composition.

12. The method of claim 10, wherein the fluoropolymer comprises polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, ethylene chlorotrifluoroethylene, or a combination thereof.

13. The method of claim 10, wherein the encapsulating polymer comprises a styrene-acrylonitrile copolymer, an acrylonitrile-butadiene-styrene copolymer, alpha-alkyl-styrene-acrylonitrile copolymer, an alpha-methylstyrene-acrylonitrile copolymer, a styrene-butadiene rubber, a methyl methacrylate copolymer, or a combination thereof.

14. The method of claim 10, wherein the temperature is between 40° C. and 280° C.

15. The method of claim 10, wherein the combining occurs for between 10 and 15 minutes or less than 7 minutes.

16. The method of claim 10, wherein the epoxy-containing component is bisphenol A diglycidyl ether.

17. The method of claim 10, wherein the polyester component is a polyalkylene terephthalate.

18. The method of claim 10, wherein the transesterification catalyst is zinc(II)acetylacetonate.

19. An article comprising the polymer composition prepared according to the method of claim 10.

20. A method comprising:
combining in an extruder
an epoxy-containing component;
a carboxylic acid component or a polyester component;
a fibrillated fluoropolymer, a fibrillated fluoropolymer encapsulated by an encapsulating polymer, or a combination thereof, and
a transesterification catalyst
to form a mixture; and
forming a network through heat treatment to form a dynamically cross-linked polymer composition,
wherein the dynamically cross-linked composition comprises 0.1 wt. % to 15 wt. %, based on the weight of the polymer composition, of a fibrillated fluoropolymer, a fibrillated fluoropolymer encapsulated by an encapsulating polymer, or a combination thereof.
